(19) United States
(12) Patent Application Publication
(10) Pub. No.: US 2010/0155217 A1
(43) Pub. Date: Jun. 24, 2010

(54) METHOD FOR HEATING OR COOLING MATERIAL IN A CONTAINER

(75) Inventors: Walter Krüger, Verden/Aller (DE); Gebhard Kregel, Verden/Aller (DE)

Correspondence Address: FULBRIGHT & JAWORSKI, LLP, 1301 MCKINNEY, SUITE 5100, HOUSTON, TX, 77010-3095, US

(73) Assignee: MARS INCORPORATED, McLean, VA (US)

(21) Appl. No.: 12/513,579

(22) PCT Filed: Dec. 17, 2007
(86) PCT No.: PCT/EP2007/011053

§ 371 Date: Jan. 19, 2010

(30) Foreign Application Priority Data
Dec. 29, 2006 (DE) 10 2006 062 088.7

(51) Int. Cl. B01D 3/42

(52) U.S. Cl. 203/2

(57) ABSTRACT

The present invention relates to a method for heating or cooling material in a container inside a pressurized retort, in which the container is moved and heated or cooled. A temperature sensor disposed in or on the container is connected to a control means, which control means is connected to a drive, to move the container in the retort and the control means controls the drive and/or the movement of the container on the basis of the container temperature measured, and a pressurized retort suitable for that purpose is also included.

### CROSS-REFERENCE TO RELATED APPLICATIONS

This Application is a National Stage of International Application PCT/EP2007/011053 filed on Dec. 17, 2007 which claims priority to Application 10 2006 062 088.7 filed on Dec. 29, 2006 in Germany.

### TECHNICAL FIELD

The present invention relates to a method for heating or cooling material in a container.

### BACKGROUND OF THE INVENTION

Pressurized retorts are used especially (though not exclusively) in methods for thermally treating packaging containers, such as tins, containing a food product for human or animal consumption. In the process, it is normally the case that food products are filled into empty tins up to an appropriate level, a head space being kept free above the product; the open ends of the tins are then hermetically sealed with end caps, and the tins with the material contained in them are sterilized with heat. The heating medium used in this process is usually steam or hot water at a temperature of usually between 115° C. and 130° C.

It is known that the time for heating up, or for cooling down after sterilization, can be reduced considerably by moving the container placed in the pressurized retort. EP 0 804 095 B1, for example, shows that times for heating up or cooling down can be reduced by at least 90% if the acceleration of the containers inside the retort is set to specific minimum values.

Rapid heating because of a greater acceleration of the containers can, however, potentially entail the risk that the product characteristics of the material filled in the container might be destroyed. The consequence of this is that the material, especially food products, often look unappetizing after the sterilization process and after the container has been opened, which is not accepted by the consumer. There is therefore a need in the art to provide a method with which the products to be sterilized can be sterilized as quickly as possible by being moved in a pressurized retort, while at the same time the product contained in the containers can be treated as gently as possible.

It is therefore an object of the present invention to provide a method for heating or cooling material in a container inside a pressurized retort which overcomes the disadvantages of the state of the art, especially one which allows rapid heating or cooling of the interior of the pressurized retort, but which does not impair the properties of the material, especially the mechanical properties.

A further object consists in providing a pressurized retort in which the method of the invention can be carried out.

### BRIEF SUMMARY OF THE INVENTION

This object is achieved by a method for heating or cooling material in a container inside a pressurized retort, in which the container is moved and heated or cooled, wherein a temperature sensor disposed in or on the container is connected to a control means, which control means is for its part connected to drive to move the container in the retort and controls the drive and/or the movement of the container on the basis of the container temperature measured and a predetermined heating or cooling curve for the material.

In this context, it is preferable that the control means controls the drive via its amplitude and/ or its frequency.

It is also proposed that the control means controls a change in the type of movement performed by the container.

In this context, it is preferable that the type of movement performed by the container is at least occasionally multi-dimensional.

It can also be provided that the movement of the container is controlled on the basis of a law of motion.

One embodiment is characterized by the fact that the drive is controlled on the basis of a time-temperature program, the temperature in the interior of the container being measured.

Finally, it is preferable that the container filled with material should have a head space.

The object is further achieved by a device for heating or cooling material in a container, which can be moved and heated or cooled inside the retort, with a temperature sensor being disposed in or on the container, said temperature sensor being connected to a control means, the control means in turn being connected to a drive to move the container in the retort.

It has surprisingly been found that, with the method of the invention, it is possible to control the temperature of the sterilization process inside the pressurized retort by having the drive to move the container inside the retort controlled on the basis of the temperature measured on or in the container and on the basis of a predetermined heating or cooling curve. Depending on the temperature measured, the drive can then be set in such a way as to obtain the optimum balance between rapid heating or cooling of the container and treating the material filled in the container as gently as possible and preserving the texture of the material. The optimum balance during heating or cooling can be determined in preliminary experiments, preferably depending on the desired target temperature, the product (viscosity, for example), etc. The method of the invention also covers a process in which, in order to obtain the best possible results, the movement and heating or cooling of the container is stopped, at least occasionally. The at least temporary termination of the movement of the container can make sense, for example, if no further increase or reduction in the temperature can be achieved with a continued movement.

In a particularly preferred embodiment, the drive is controlled by changing the amplitude and/ or frequency of a freely programmable linear drive, for example. These changes result in changes in the acceleration with which the container can be moved to and fro inside the retort. Similarly, it is preferably provided that the type of movement of the container inside the retort can also be changed. One-dimensional and multi-dimensional movements, for example, are conceivable. Especially for multi-dimensional movements, it is believed that the time for heating or cooling the container can be reduced still further. The movement can be performed on the basis of all known laws of motion. In particular, it is also provided that the drive is controlled on the basis of a time-temperature program, the temperature preferably being measured in the interior of the container. It is, for example, possible to specify a desired heating-up or cooling-down time, and the control means then controls the drive accordingly, in order to heat up or cool down the container inside the retort in the desired time, taking account of, for example, the optimum values for the amplitude and frequency of the drive, in order to treat the product as gently as possible.

Further features and advantages of the method of the invention will become apparent from the following detailed description of the preferred embodiments in combination with the drawing.

### BRIEF DESCRIPTION OF THE DRAWINGS

FIG. 1 shows a cross-section through a pressurized retort in accordance with the invention which is suitable for the method.

### DETAILED DESCRIPTION OF THE INVENTION

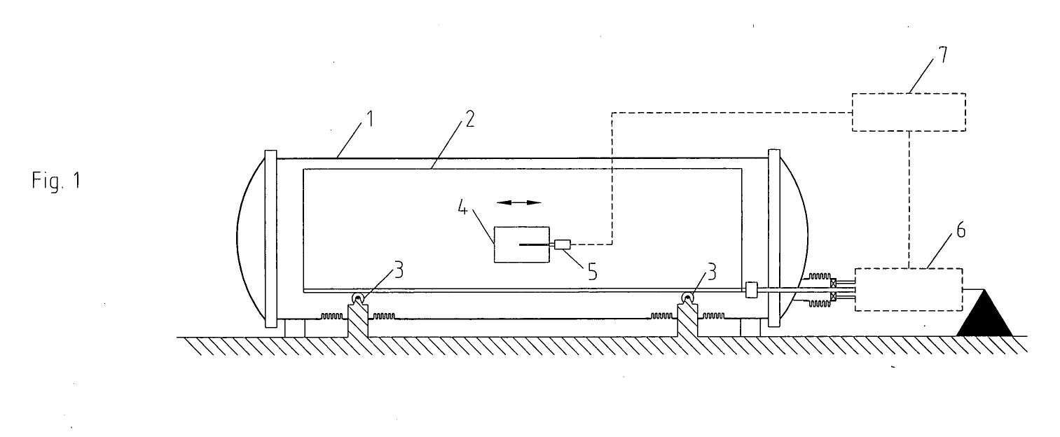

FIG. 1 shows a pressurized retort 1 in which the method can be carried out. A receptacle 2 on bearings 3 is disposed in the retort 1, in which receptacle 2 a plurality of containers 4 may be disposed, though for the sake of clarity only one container 4 is shown, into which a temperature sensor 5 has been placed. The receptacle 2 with the container 4 contained therein can be moved to and fro inside the retort by the drive 6, as indicated by the double arrow in FIG. 1. The temperature sensor 5 is connected to a control means 7, which in turn is connected to the drive 6. When the retort 1 shown is operated, such as in a sterilization process in which the content of the container 4 is to be heated, heating medium, usually steam or hot water, is introduced into or removed from the retort, for example via inlet and outlet ports (not shown). During the process, the temperature inside the container 4 is measured by the temperature sensor 5, which passes on the value determined to the control means 7. The control means 7 processes the temperature value determined and, if necessary, controls the drive 6 so that the heating takes place under optimum and rapid conditions, though without placing an excessive burden on the material contained in the containers 4. In this context, the drive 6 can be controlled particularly preferably by controlling the frequency and amplitude of the drive, which may, for example, be a crank drive.

By controlling the drive, it is possible to increase the temperature inside the container 4 as desired. The method of the invention is not a static method in which parameters cannot be changed, but is rather a method in which the parameters, such as the frequency and amplitude of the drive, can be changed, also periodically for example.

The features of the invention disclosed in the above description, in the claims and in the drawing can be essential to implementing the invention in its various embodiments both individually and in any combination.

1. A method for heating or cooling material in a container inside a pressurized retort, comprising the steps of:
moving a container inside a pressurized retort in which the container is heated or cooled;
providing a temperature sensor disposed in or on the container in which the sensor is connected to a control means;
the control means being connected to a drive configured to move the container in the retort in which the control means controls the drive and/or the movement of the container on the basis of the measured temperature of the container and a predetermined heating or cooling curve for the material.

2. The method as claimed in claim 1, wherein the control means controls the drive via its amplitude and/or its frequency.

3. The method as claimed in claim 1, wherein the control means also controls a change in the type of movement performed by the container.

4. The method as claimed in claim 3, wherein the type of movement of the container is at least occasionally multi-dimensional.

5. (canceled)

6. The method as claimed in claim 1, wherein the drive is controlled on the basis of a time-temperature program, in which the temperature in the interior of the container being measured.

7. The method as claimed in claim 1, wherein the container filled with material has a head space.
